(19) United States
(12) Patent Application Publication
(10) Pub. No.: US 2012/0318776 A1
(43) Pub. Date: Dec. 20, 2012

(54) METHOD AND APPARATUS FOR MACHINING A WORKPIECE

(75) Inventor: Mathew Rekow, Santa Cruz, CA (US)

(73) Assignee: ELECTRO SCIENTIFIC INDUSTRIES, INC., Portland, OR (US)

(21) Appl. No.: 13/598,057

(22) Filed: Aug. 29, 2012

Related U.S. Application Data
(63) Continuation-in-part of application No. 13/078,787, filed on Apr. 1, 2011.
Application No. 13/078,787 is a continuation-in-part of application No. 12/889,435, filed on Sep. 24, 2010.
(60) Provisional application No. 61/245,582, filed on Sep. 24, 2009.

(51) Int. Cl. B23K 26/40; B23K 26/38

(52) U.S. Cl. 219/121.69; 219/121.68

(57) ABSTRACT

Numerous embodiments of methods and apparatus for machining workpieces using one or more optical pulses are disclosed. One embodiment of a method of machining a Workpiece includes directing an optical pulse to impinge upon a surface of the workpiece. The optical pulse can be configured to initiate a vaporization process within a first period of time after impinging upon the workpiece surface. After the first period of time, a characteristic of the optical pulse is changed while maintaining the initiated vaporization process and, after a second period of time, the optical pulse is terminated to terminate the maintained vaporization process. Exemplary articles that may be produced by machining workpieces are also disclosed.

### CROSS-REFERENCE TO RELATED APPLICATIONS

This application is a Continuation-In-Part of prior application Ser. No. 13/078,787, filed Apr. 1, 2011, which is a Continuation-In-Part of prior application Ser. No. 12/889,435, filed Sep. 24, 2010, which claims the benefit of the benefit of U.S. Provisional Application No. 61/245,582, filed Sep. 24, 2009, the disclosures of all of which are hereby incorporated by reference in their entirety for all purposes.

### BACKGROUND

Embodiments of the present invention relate generally to machining workpieces. More particularly, embodiments of the present invention relate to methods and apparatus for removing material from a structure of a workpiece.

Pulsed laser sources, such as Nd:YAG lasers, have been used to perform laser-based machining (e.g., marking, engraving, micro-machining, cutting, scribing, etc.) of materials for various applications. Depending on the application and the materials to be processed, it can be advantageous to be able to select the various characteristics of the optical pulses, including pulse energy, pulse width, pulse repetition rate, peak power or energy, and pulse shape, as appropriate to the particular application. Many examples exist of the careful control of pulse energy and power to optimize various materials processing applications. Many existing high-power pulsed lasers that are characterized by pulse energies greater than 0.5 mJ per pulse, rely on techniques such as Q-switching and mode locking to generate optical pulses. However such lasers produce optical pulses with characteristics that are predetermined by the cavity geometry, mirror reflectivities, and the like. Using such lasers, it is generally difficult to achieve an optimal pulse shape for the application at hand and therefore in many cases the laser processing has some deficiencies. Therefore, what is needed is a method and apparatus for machining workpieces that improve the quality and the yield of the machining process.

### SUMMARY

One embodiment exemplarily described herein can be characterized as a method of machining a workpiece, wherein the method includes providing a workpiece including a structure having a first surface and a second surface opposite the first surface, wherein the first and second surfaces are defined by the same material; and forming a recess within the structure, wherein the recess extends into the structure from the first surface and terminates at a recessed surface spaced apart from the second surface. The recess may, in turn, be formed by a process that includes directing a first optical pulse to impinge upon a first region of the first surface of the structure, wherein the first optical pulse is configured to initiate a vaporization process within a first period of time after impinging upon the first region; after the first period of time, changing a characteristic of the first optical pulse while maintaining the initiated vaporization process; and, after a second period of time, terminating the first optical pulse to terminate the maintained vaporization process.

Another embodiment exemplarily described herein can be characterized as a method of machining a workpiece, wherein the method includes providing a workpiece including a structure having a measurable thickness between a first surface and a second surface opposite the first surface, wherein the first and second surfaces are defined by the same material; and reducing the thickness of at least a portion of the structure to form a thinned region within the structure. The thickness may, in turn, be reduced by a process that includes directing an optical pulse to impinge upon the first surface of the structure, wherein the optical pulse is configured to generate a vaporization front at the first surface within a first period of time after impinging upon the first surface; after the first period of time, changing a characteristic of the optical pulse while advancing the vaporization front into the structure and toward the second surface; and, after a second period of time, extinguishing the vaporization front.

Still another embodiment exemplarily described herein can be characterized as an apparatus for machining a workpiece, wherein the apparatus includes a workpiece handling system configured to support a workpiece that includes a structure having a first surface and a second surface opposite the first surface, wherein the first and second surfaces are defined by the same material; an optical source operative to generate an optical pulse that is directable onto the first surface of the structure; and a controller coupled to the optical source. The controller may include a memory; and a processor configured to execute instructions stored in the memory to control the optical source to: direct an optical pulse to impinge upon the first surface of the structure, wherein the optical pulse is configured to initiate a vaporization process within a first period of time after impinging upon the first surface; after the first period of time, change a characteristic of the optical pulse to maintain the initiated vaporization process; and, after a second period of time, terminate the optical pulse to terminate the maintained vaporization process.

### BRIEF DESCRIPTION OF THE DRAWINGS

FIGS. 1 to 4 illustrate one embodiment of a process of machining a workpiece.

FIG. 5 is a graph showing a relationship between peak power of a temporally-shaped optical pulse directed onto a structure to generate a vaporization front and the resultant temperature of material within the structure at the vaporization front.

FIG. 6 is a top plan view exemplarily illustrating a pattern of regions of the surface of a structure upon which corresponding optical pulses can be directed to impinge.

FIG. 7 is a cross-section view taken along line VII-VII in FIG. 6 exemplarily illustrating a recess that may be formed upon machining a workpiece according to one embodiment.

FIG. 8 is a schematic view exemplarily illustrating one embodiment of an apparatus for machining a workpiece.

### DETAILED DESCRIPTION OF THE ILLUSTRATED EMBODIMENTS

Exemplary embodiments of the present invention will be described more fully hereinafter with reference to the accompanying drawings. It will be appreciated that these embodiments may be altered and implemented in many other forms and should not be construed as limited to the discussion set forth herein. Rather, these embodiments are provided so that this disclosure will be thorough and complete, and will fully convey the scope of the invention to those skilled in the art. In the drawings, the sizes and relative sizes of layers and regions may be exaggerated for clarity.

The terminology used herein is for the purpose of describing particular example embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Generally, embodiments disclosed herein are directed to methods and apparatus for machining a workpiece. In one embodiment, the workpiece includes a structure having a first surface and a second surface opposite the first surface wherein the first and second surfaces are defined by the same material. Thus, the structure can be provided as a single layer of material or can be a multi-layer structure (e.g., composed of three or more layers of different materials, wherein two layers formed of the same material are spaced apart from each other by another layer formed of a different material). Generally, the material of the structure can be any desired or beneficial chemical substance. As used herein, a “chemical substance” broadly refers to any chemical element, any organic or inorganic chemical compound, or any mixture thereof. The material may have a substantially homogenous composition and/or substantially homogenous property over a length scale of at least 10 μm, at least 10 nm, or the like. For example, the material can include at least one selected from the group consisting of a metal (e.g., Al, Fe, Cu, Zn, Ga, Mo, Cd, In, Sn, or the like, an oxide thereof, a nitride thereof, or any combination or alloy thereof), a metalloid (e.g., Si, Ge, Te, or the like, an oxide thereof, a nitride thereof, or any combination or alloy thereof), a semiconductor (e.g., Si, Ge, GaN, SiC, GaAs, AlGaAs, InGaN, AlN, or the like, or any combination or alloy thereof), a glass (e.g., fused quartz glass, fused silica glass, soda-lime glass, borosilicate glass, aluminosilicate glass, aluminoborosilicate glass, or the like or any combination thereof) and a polymer (e.g., polyester, polyamide, polyolefin, polycarbonate, poly(methyl methacrylate), polyetheretherketone, polyimide, rubber, epoxy resin, fluoropolyrner, or the like or any combination thereof), or the like or a combination thereof. Specific examples of materials from which the structure 102 can be formed include silicon (e.g., amorphous, monocrystalline, polycrystalline, etc.), cadmium telluride, copper indium diselenide, copper indium gallium diselenide, zinc oxide, aluminum-doped zinc oxide, tin oxide, fluorine doped tin oxide, indium tin oxide (ITO), indium-doped cadmium oxide, molybdenum, or the like or any combination or alloy thereof.

In one embodiment, the workpiece includes a substrate and the structure is located on the substrate. The substrate may be formed of one or more materials, one or more layers of materials, or the like. Moreover, the substrate may be permanently fixed to the structure (e.g., by an intervening adhesive material, directly by a chemical or electrostatic bond with the structure, or the like or a combination thereof), physically removable from the structure (e.g., by an intervening dissolvable adhesive material, or the like or a combination thereof), sacrificially destroyable with respect to the structure, or the like. The substrate can include any material such as that described above with respect to the structure, or any other material. Generally, the substrate may be rigid or flexible, may provide structural support for the structure 102 (e.g., during machining of the workpiece, formation of the structure, transport of the workpiece, etc.), may provide a surface upon which the structure can be formed, or the like or any combination thereof. In yet another embodiment, the substrate may be omitted and the workpiece may consist only of the structure.

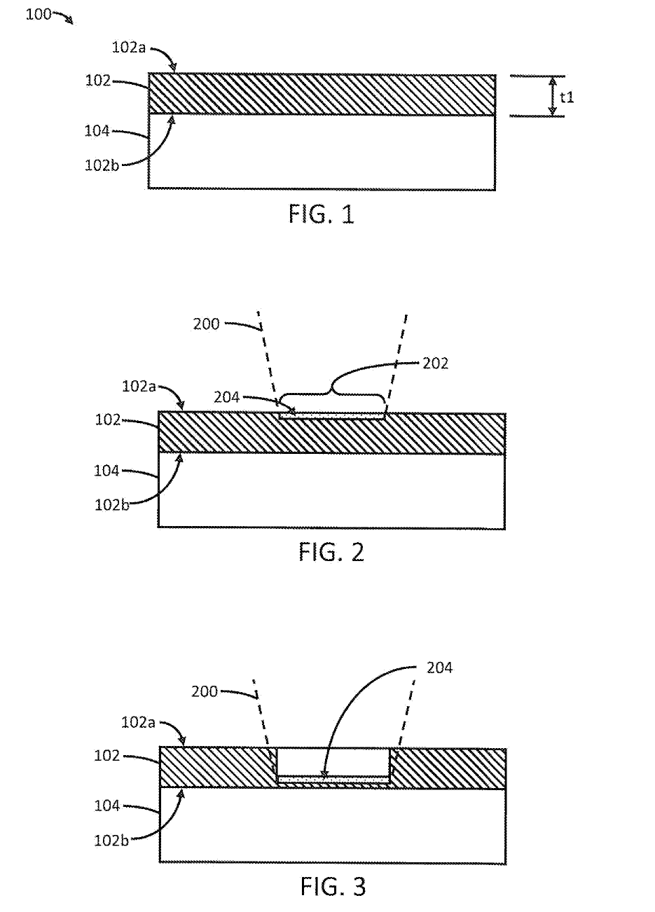

In the embodiments exemplarily discussed below with reference to FIGS. 1 to 7, a workpiece is intended to be machined by forming a recess within the structure provided as a single layer of material, wherein the recess extends only partially through the structure. It will be appreciated, however, that the methods and apparatus described herein can be applied to machine a recess in a multi-layer structure, and that workpiece can be machined to form any number of holes, slots, openings, etc., that extend completely through either a single layer or multi-layer structure.

FIGS. 1 to 4 illustrate one embodiment of a process of machining a workpiece. FIG. 5 is a graph showing a relationship between peak power of a temporally-shaped optical pulse directed onto a structure to generate a vaporization front and the resultant temperature of material within the structure at the vaporization front.

Referring to FIG. 1, a workpiece 100 may be provided to include a structure, such as structure 102, having a first surface 102a and a second surface 102b opposite the first surface 102a. Optionally, the structure 102 may be located on a substrate such as substrate 104. As exemplarily illustrated, the structure 102 can provided as a film having a thickness, t1, measured from the first surface 102a to the second surface 102b in a range from 25 nm to 2 μm. In one embodiment, the thickness, t1, of the structure 102 is in a range from about 100 nm to about 500 nm. However it will be appreciated that the thickness, t1, of the structure 102 may be less than 25 nm or greater than 2 μm.

Referring to FIG. 2, an optical pulse such as optical pulse 200 may be directed to impinge upon a region 202 of the first surface 102a of the structure 102. In one embodiment, the optical pulse 200 has a non-Gaussian intensity profile (e.g., a flat-top or top-hat pulse) having a cross-sectional area (i.e., spot shape) that is circular, elliptical square, rectangular, or any other homogenized shape. In another embodiment, the intensity profile of the optical pulse 200 may be Gaussian. Although FIG. 2 illustrates the region 202 as extending across only a portion of the first surface 102a, it will be appreciated that the region 202 may extend over the entirety of the first surface 102a. Characteristics of the optical pulse 200 (e.g., wavelength, peak power, spot size at a surface of the structure 102, spot shape, etc.) are selected such that, within a first period of time (e.g., first period of time T1 as shown in FIG. 5) after the optical pulse 200 initially impinges upon the structure 102, a vaporization front 204 is generated within the region 202 of the first surface 102a of the sample 102. Within the vaporization front 204, material of the structure 102 is heated at or above a vaporization temperature (e.g., Tᵥₐₚ as shown in FIG. 5) and is vaporized in a vaporization process. Depending on factors such as the material of the structure 102, the fluid pressure within a region adjacent to the structure 102, and the like, the vaporization temperature Tᵥₐₚ can be in a range from 1,200° C. to 2,800° C. in one embodiment, the vaporization temperature Tᵥₐₚ is in a range from 1,500° C. to 2,300° C. In another embodiment, the vaporization temperature Tᵥₐₚ is in a range from 1,700° C. to 2,100° C. In yet another embodiment, the vaporization temperature Tᵥₐₚ is in a range from 1,800° C. to 2,000° C. It will nevertheless be appreciated that the vaporization temperature Tᵥₐₚ can be less than 1,200° C. or greater than 2,800° C. Outside the vaporization front 204 however the vaporization process is not initiated, so the material of the structure 102 is not vaporized.

Generally, the shape of the vaporization front 204 (e.g., when viewed in a top plan view) corresponds to the shape of the spot of the optical pulse 200 impinging upon the region 202. For example, when the spot shape of the optical pulse 200 is circular in shape having a diameter in a range from 10 μm to 50 μm, the vaporization front 204 may also be circular in shape having a diameter in a range from 10 μm to 50 μm. It will be appreciated, however, that the diameter of the vaporization front 204 may be less than 10 μm or more than 50 μm. It will also be appreciated that the vaporization front 204 may be elliptical, square, rectangular, or any suitable shape other than circular. Depending upon factors such as the wavelength of the optical pulse 200 and material properties (e.g., mass density, melting temperature, latent heat of fusion, specific heat, thermal conductivity, refractive index, etc.) of the material of the structure 102, the height of the vaporization front 204 during the first period of time T1 may be less than 50 nm. In one embodiment, the height of the vaporization front 204 during the first period of time T1 is less than 20 nm. In another embodiment, the height of the vaporization front 204 during the first period of time T1 is less than 10 nm. It will be appreciated, however, that the height of the vaporization front 204 during the first period of time T1 can be more than 50 nm.

Products of the vaporization process can include a plasma, a gas, a vapor, an aerosol, small particles, or the like or a combination thereof, that can be entrained by one or more fluids (e.g., a flow of water, air, nitrogen gas, or the like or a combination thereof) adjacent to the structure 102 to thereby be transported away from the structure 102. In this way, material within the vaporization front 204 can be removed from the structure 102. In one embodiment, the vaporization process can be described as an endothermic process involving a chemical reaction within the material, a phase transition within the material, or the like or a combination thereof. When the material of the structure 102 is a chemical compound having two or more chemical elements or a mixture of at least two chemical substances, the vaporization process can, in one embodiment, include a chemical reaction such as a chemical dissociation or degradation of the material. When the material of the structure 102 is a chemical compound or other chemical substance, the vaporization process can, in one embodiment, include a phase transition such as melting, evaporation, sublimation, or any combination thereof, of the material. It will be appreciated that, in some cases, the vaporization process can also include ablation process involving one or more photoionization modes or mechanisms. In another embodiment, the vaporization process can be described as an exothermic process involving a chemical reaction (e.g., combustion, oxidation, etc.) within the material in which the reaction rate is slower than the rate at which heat generated by the exothermic process is removed from the vicinity of the vaporization front 204 (also referred to herein as the “heat loss rate”). In yet other embodiments (e.g., in which the material of the structure has more than one crystal structure, etc.), the vaporization process can be described as a mixture of endothermic and exothermic reactions.

In one embodiment, the first period of time T1 can have a duration in a range from 0.1 ns to 5 ns. In one embodiment, the first period of time T1 can have a duration of 2 ns. However depending on factors such as the material of the structure 102, the peak power of the optical pulse during the first period of time T1, fluid pressure within the region adjacent to the structure 102, and the like, it will be appreciated that the duration of the first period of time T1 may be less than 0.1 ns or greater than 5 ns.

In one embodiment, the optical pulse 200 is a laser pulse (also referred to herein as a “laser pulse 200”) of light having a wavelength to which the structure 102 is at least substantially transparent. As used herein, the structure 102 is “substantially transparent” to a wavelength of light if the structure 102 has a light transmittance of at least 90% with respect to the wavelength. As used herein, the light transmittance of the structure 102 refers to the fraction of incident light (e.g., light incident on the first surface 102a) having aforementioned the wavelength that passes through the thickness t1 of the structure 102 (e.g., that is transmitted through the second surface 102b). In other embodiments, the structure 102 has a light transmittance of at least 98%, at least 99% or 100%. In other words, the structure 102 absorbs 10% or less of the energy in the light of the laser pulse 200. In another embodiment however, the structure 102 has a light transmittance of less than 90% with respect to the wavelength of the light within the laser pulse 200. After the vaporization process has been initiated, the light transmittance can decrease by an amount that is difficult to measure. Therefore, and for purposes of discussion, the “light transmittance” referred to herein relates to the light transmittance of the structure 102 refers to the light transmittance of the structure 102 before the vaporization process is initiated. It will be appreciated that the wavelength of light within the laser pulse 200 can depend upon the material from which the structure 120 is formed and the thickness t1 of the structure 102. In one embodiment, light within the laser pulse 200 has a wavelength in the infrared range of the electromagnetic spectrum (e.g., 1032 nm, 1064 nm, 1300 nm, 1500 nm, 2000 nm, or the like). It other embodiments, the light within the laser pulse 200 can have a wavelength in another range of the electromagnetic spectrum such as the green range in the visible portion of the electromagnetic spectrum (e.g., at 532 nm, or the like), the near ultraviolet portion of the electromagnetic spectrum, the ultraviolet portion of the electromagnetic spectrum, and the like.

As used herein, the term “peak power” refers to the rate of energy flow in the optical pulse, and can be calculated according to the following equation:

$${P}_{peak} = \frac{E}{Δ t}$$

where Pₚₑₐₖ is the peak power, and E (e.g., typically measured in μJ) is the energy contained in the optical pulse within a period of time Δt (e.g., typically measured in ns). Therefore, in one embodiment, the peak power of the optical pulse 200 during the first period of time T1 (e.g., PP1 as shown in FIG. 5) can be in a range from 500 W to about 20 kW. However depending on factors such as the material of the structure 102, the wavelength of light in the laser pulse 200, the duration of the first period of time T1, and the like, it will be appreciated that the peak power of the optical pulse 200 during the first period of time T1 can be less 500 W or greater than 20 kW. During the first period of time T1, the power PP1 of the optical pulse 200 can be constant or can change.

An endothermic vaporization process can terminate (i.e., the vaporization front 204 can be extinguished) if the optical pulse 200 is terminated or if an insufficient amount of energy is provided by the optical pulse 200. Similarly, an exothermic vaporization process (i.e., in which the reaction rate is less than the heat loss rate) can terminate (i.e., the vaporization front 204 can be extinguished) if the optical pulse 200 is terminated or if an insufficient amount of energy is provided by the optical pulse 200. However, if the energy content of the optical pulse 200 is not suitably reduced, then undesirable thermal effects (e.g., cracks, recrystallization zones, etc.) may be generated within regions of the structure 102 outside, but adjacent to, the vaporization front 204. Accordingly at the end of the first period of time T1, one or more characteristics of the optical pulse 200 are changed to reduce the energy input to the material during the first period of time T1, but to still provide enough energy to maintain the temperature of the material at or above the vaporization temperature Tᵥₐₚ, thereby maintaining the initiated vaporization process (e.g., while avoiding or reducing the undesirable formation of cracks in the structure 102). The optical pulse 200 having the one or more changed characteristics is then directed to impinge upon the structure 102 for an additional second period of time (e.g., second period of time T2 as shown in FIG. 5) to advance the vaporization front 204 further into the structure 102 toward the second surface 102b (e.g., as shown in FIG. 3). In one embodiment, one or more characteristics of the optical pulse 200 may be changed such that, during the second period of time T2, the height of the vaporization front 204 is 20 nm or less. In another embodiment, the height of the vaporization front 204 during the second period of time T2 is 10 nm or less. It will be appreciated, however, that the height of the vaporization front 204 during the second period of time T2 can be more than 20 nm.

In one embodiment, the second period of time T2 has a duration in a range from 1 ns to 600 ns. In another embodiment, the second period of time T2 can have a duration in a range from 5 ns to 50 ns. In yet another embodiment, the second period of time T2 can have a duration in a range from 10 ns to 25 ns. However depending on factors such as the material of the structure 102, the thickness, t1, of the structure 102, the desired depth of the recess to be formed, and the like, it will be appreciated that the duration of the second period of time T2 may be less than 1 ns or greater than 600 ns.

In one embodiment, only the peak power of the optical pulse 200 is reduced at the end of the first period of time T1 (e.g., from peak power PP1 to peak power PP2 as shown in FIG. 5) to maintain the vaporization process and advance the vaporization front 204. In one embodiment, the peak power PP2 can in a range of 5% to 50% of the highest peak power PP1 attained during the first period of time T1. For example, the peak power PP2 is in a range from 100 W to 1 kW. However depending on factors such as the material of the structure 102, the thickness, t1, of the structure 102, the desired depth of the recess to be formed, the desired texture and geometry of surfaces exposed to the recess, and the like, it will be appreciated that the peak power PP2 can be less than 5% or greater than 50% of the highest peak power PP1 attained during the first period of time T1 (or can be less than 100 W or greater than 1 kW). During the second period of time T2, the peak power PP2 of the optical pulse 200 can be constant or can change.

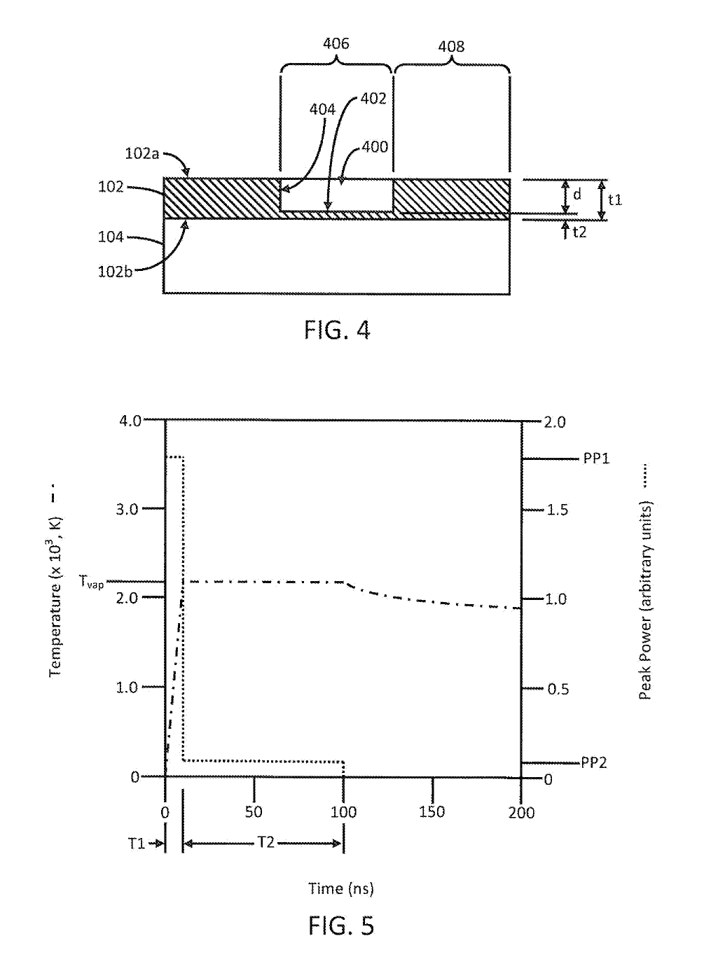

Referring to FIG. 4, after the second period of time T2 has elapsed, the optical pulse 200 is terminated. Upon terminating the optical pulse 200 the vaporization front 204 is extinguished and the vaporization process within the structure 102 can be terminated. As a result, a recess 400 is formed in the structure 102. The recess 400 terminates in a recessed surface 402 that is spaced apart from the second surface 102b of the structure 102. Due to the nature of the vaporization process described above, the depth and surface morphology of the recess 400 is substantially controlled by the vaporization rate of the material of the structure 102 (i.e., the rate at which material within the vaporization front 204 becomes vaporized), and is substantially independent the peak power or energy of the optical pulse 200. Further, it has been discovered that the recessed surface 402 remains substantially flat regardless of whether the intensity profile of the optical pulse 200 is Gaussian or non-Gaussian. In one embodiment, the recessed surface 402 is formed in the same material from which the first surface 102a is formed. In one embodiment, one or more characteristics of the optical pulse 200 are controlled such that the recessed surface 402 is substantially smooth and flat. In another embodiment, one or more characteristics of the optical pulse 200 are controlled such that the recessed surface 402 is substantially parallel to the first surface 102a.

As exemplarily illustrated, the recess 400 also includes sidewalls 404 extending from the first surface 102a to the recessed surface 402. In one embodiment, one or more characteristics of the optical pulse 200 are controlled such that the sidewalls 404 are at least substantially perpendicular to the recessed surface 402, the first surface 102a or a combination thereof. Thus the width of the recess 400 at the recessed surface 402 may be substantially equal to the width of the recess 400 at the first surface 102a of the structure 102. In one embodiment, the width of the recess 400 may be in a range from 10 μm to 500 μm. It will be appreciated, however, that the width of the recess 400 may be less than 10 μm or more than 500 μm. However, depending upon factors such as the depth of the recess 400, the spot shape and spot size of the optical pulse 200 during the second period of time T2, and the like, the sidewalls 404 may be tapered, stepped, etc., in any manner so as to vary the width of the recess as the depth of the recess 400 changes.

Generally, the depth, d, to which the recess 400 extends into the structure 102 can be defined as the distance from the first surface 102a to the recessed surface 402 and is typically in a range from 10 nm to 1 mm. However depending on factors such as the material of the structure 102, the characteristics of the optical pulse during the first period of time T1 and/or the second period of time T2, the duration of the first period of time T1 and/or the second period of time T2, and the like, it will be appreciated that the depth, d, of the recess 400 may be less than 10 nm or greater than 1 mm. In one embodiment, a difference between the depth, d, of the recess 400 and the thickness, t1, of the structure 102 (represented as thickness, t2) may be in a range from 10 nm to 500 nm. In other embodiments, however, the difference between the depth, d, of the recess 400 and the thickness, t1, of the structure 102 (i.e., thickness, t2) may be less than 10 nm or more than 500 nm. Accordingly, the above-described process of forming the recess 400 can also be considered as a process of reducing the thickness of the structure 102 to produce a processed or “thinned” region 406 having a reduced thickness, t2, that is less than the thickness, t1, of another region (e.g., region 408) of structure 102. As will be appreciated, the size, location and shape (when viewed in a top plan view) of the thinned region 406 within the structure 102 can correspond to the size, location and shape (when viewed in a top plan view) of the first region 102a of the first surface 102. Depending on the factors such as the material from which the structure 102 is formed, the thicknesses t1 or t2 of one or both of the regions 408 and 406, respectively, the area of the thinned region 406 (e.g., when viewed from a top plan view), one or more properties (e.g., optical, electrical, thermal, or the like or a combination thereof) of the structure 102 at the thinned region 406 may be different from one or more corresponding properties of the structure 102 at another region (e.g., region 408). Examples of an optical property that may differ between the thinned region 406 and the other region 408 include optical absorption, optical emission, optical reflection, optical transmission, or the like or a combination thereof. An example of an electrical property that may differ between the thinned region 406 and the other region 408 includes electrical conductivity. Similarly, an example of a thermal property that may differ between the thinned region 406 and the other region 408 includes thermal conductivity.

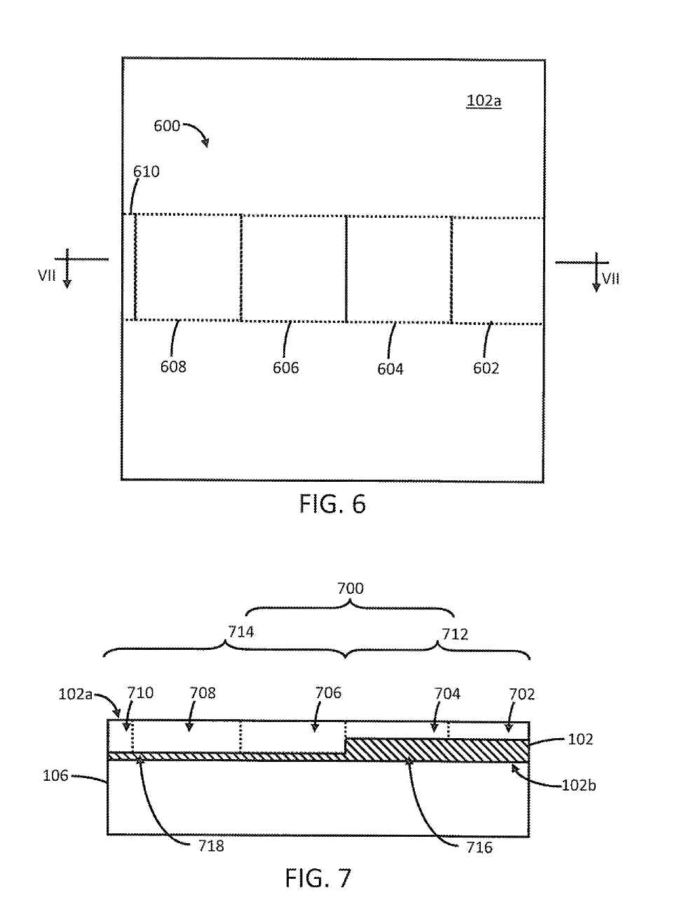

In the embodiments discussed above with respect to FIGS. 1 to 5, a recess 400 is formed by directing an optical pulse 200 onto only one region (e.g., region 202) of the first surface 102a of the structure 102. In other embodiments, however, a recess may also be formed by sequentially directing the optical pulse 200 onto multiple regions of the first surface 102a, by directing multiple optical pulses such optical pulse 200 onto different regions of the first surface 102a of the structure 102, or the like or a combination thereof. FIGS. 6 and 7 illustrate one such other embodiment of a process of machining a workpiece to form a recess.

FIG. 6 is a top plan view exemplarily illustrating a pattern of regions of the surface of a structure upon which corresponding optical pulses can be directed to impinge. FIG. 7 is a cross-section view taken along line VII-VII in FIG. 6 exemplarily illustrating a recess that may be formed upon machining a workpiece according to one embodiment.

Referring to FIGS. 6 and 7, optical pulses (e.g., each similar to optical pulse 200 discussed above, but having a square spot shape) may be directed to impinge upon a pattern 600 of regions of the first surface 102a of the structure 102. As exemplarily illustrated, the pattern 600 includes non-overlapping, but adjoining, regions 602, 604, 606, 608 and 610. It will be appreciated that any two adjacent regions may overlap one another (e.g., in range from 0% to 100% overlap). It will also be appreciated that any two adjacent regions may be spaced apart from each other (e.g., so as not to adjoin one another as illustrated, or so as not to overlap one another).

In one embodiment, the optical pulses may sequentially impinge upon regions 602, 604, 606, 608 and 610 to form a channel, trench or recess (collectively referred to simply as a “recess”) such as recess 700. For example, an optical pulse may be generated and directed to first impinge upon region 602 of the first surface 102a to form an intermediate recess 702 (e.g., as exemplarily described above with respect to FIGS. 1 to 5). After forming the intermediate recess 702, an optical pulse may be generated and directed to impinge upon region 604 of the first surface 102a to form another intermediate recess 704 (e.g., as exemplarily described above with respect to FIGS. 1 to 5). Likewise, the an optical pulse may be generated and directed to sequentially impinge upon the remaining regions 606, 608 and 610 to form intermediate recesses 706, 708 and 710, respectively. Because the locations of the regions 602, 604, 606, 608 and 610 on the first surface 102a of structure 102 overlap, the intermediate recesses 702, 704, 706, 708 and 710 communicate with each other to form recess 700. It will be appreciated, however, that the order in which the regions 602, 604, 606, 608 and 610 are irradiated need not be sequential. For example, after an optical pulse is directed to impinge upon region 602, an optical pulse may be directed to impinge upon region 606 and, thereafter, an optical pulse may be directed to impinge upon region 604.

The depth to which any region of the recess 700 extends into the structure 102 can correspond to the depth to which any intermediate recess 702, 704, 706, 708 and 710 extends into the structure 102. For example, in the embodiment shown in FIG. 7, the recess 700 includes a first recess region 712 and a second recess region 714, wherein the second recess region 714 extends into the structure 102 farther than the first recess region 712. To form the first and second recess regions 712 and 716 as illustrated, the intermediate recesses 702 and 704 can be sequentially formed to the same (or substantially the same) depth within the structure 102. Thereafter, the intermediate recess 706 can be formed to extend deeper into the structure 102 than the intermediate recesses 702 and 704 (e.g., by extending the duration of the second period of time T2 used in forming the intermediate recess 706 as compared to the duration of the second period of time T2 used in forming the intermediate recess 704). As similarly discussed with reference to FIG. 4, the above-described process of forming the first and second recess regions 712 and 716 can also be considered as a process of reducing the thickness of the structure 102 to produce first thinned region 716 and a second thinned region 718 that is thinner than the first thinned region 716. Although the recess 700 is illustrated as including only two regions of differing depths, it will be appreciated that the recess 700 may include any number of regions extending into the structure 102 to any depth. Thus, the structure 102 may be machined to produce any number of thinned regions having any thickness.

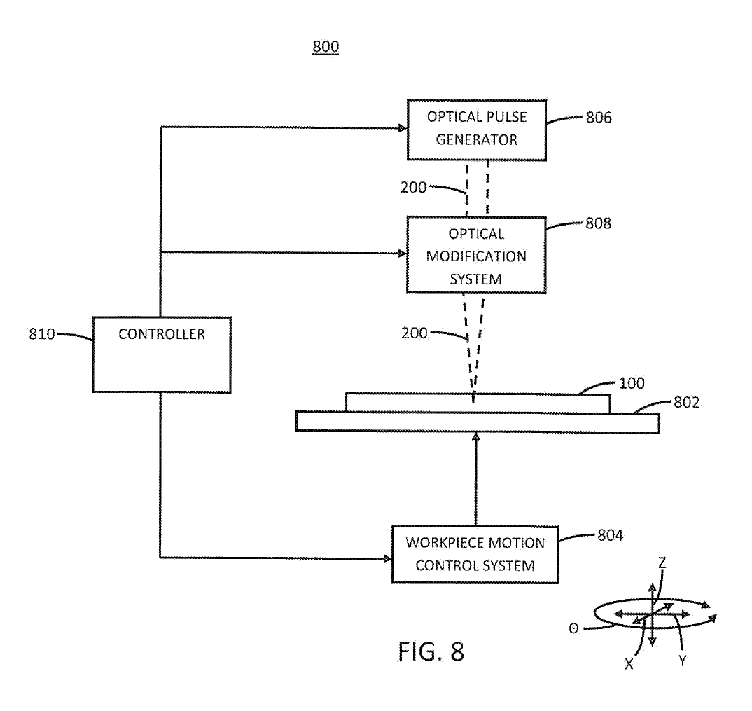

FIG. 8 is a schematic view exemplarily illustrating one embodiment of an apparatus for machining a workpiece.

Referring to FIG. 8, an apparatus, such as apparatus 800, may be configured to machine workpiece. The apparatus 800 may include a workpiece handling system 802, a workpiece motion control system 804, an optical source (e.g., including an optical pulse generator 806 and an optical modification system 808) and a controller 810.

The workpiece handling system 802 can be configured to support a workpiece including a structure (e.g., the aforementioned workpiece 100 having structure 102) and may be provided as a chuck (e.g., a vacuum chuck, an electro-static chuck, etc.), an end-effector of robot handler, a tape frame, or the like or a combination thereof.

The workpiece motion control system 804 can be configured to translate the workpiece handling system 802 in X, and/or Z directions, rotate the workpiece handling system 802 (e.g., as indicated by Θ), or the like or a combination thereof, relative to the optical modification system 808. The workpiece motion control system 804 can include one or more motors, actuators, or the like or a combination thereof.

The optical source 806 can be configured to generate optical pulses such as optical pulse 200. In one embodiment, the optical source 806 is provided as pulsed laser source as exemplarily described in U.S. Pat. No. 7,428,253, U.S. patent application Ser. Nos. 13/078,787, 12/889,435, 12/210,028, or in U.S. Provisional Application Nos. 61,186,317 or 61/245,582, each of which are incorporated herein by reference in their entirety.

The optical modification system 808 can be configured to direct optical pulses generated by the optical source to impinge upon the workpiece 100. In one embodiment, the optical modification system 808 may include one or more steering elements configured to scan optical pulses, such as optical pulse 200, relative to the workpiece 100. Examples of suitable steering elements include a galvanometric mirror or “galvo-mirror” (e.g., an X-axis galvo-mirror, a Y-axis galvo-mirror, etc.), a fast-steering mirror (FSMs), a piezo-actuated mirror, an acousto-optic deflector (AODs), an electro-optic deflector (EODs), or the like or a combination thereof. In another embodiment, the optical modification system 808 may include one or more focusing elements configured to focus optical pulses, such as optical pulse 200, directed onto the workpiece 100 such that the structure 102 can be machined as exemplarily described above. In another embodiment, the optical modification system 808 may include one or more beam shaping elements configured to spatially shape the optical pulses, such as optical pulse 200, to have a spot shape that is circular, elliptical, rectangular, square, or the like or a combination thereof.

The controller 810 may be coupled to one or more of the workpiece motion control system 804, the optical source 806 and the optical modification system 808 and control the operation of one or more of these components to machine the structure 102 of workpiece 100 as exemplarily described above. In one embodiment, the controller 810 can control the optical source 806 to generate and direct an optical pulse, such as optical pulse 200, to impinge upon the region 202 of the first surface 102a of the structure 102 such that the optical pulse 200 initiates a material removal process within a first period of time T1 after impinging upon the region 202. The controller 810 can further control the optical source 806 to change a characteristic of the optical pulse 200 while maintaining the initiated material removal process. The controller 810 can further control the optical source 806 to change a characteristic of the optical pulse 200 to terminate the maintained material removal process. Generally, the controller 810 may be an electronic circuit comprising one or more components, including digital circuitry, analog circuitry, or both. Controller 810 may be a software and/or firmware programmable type; a hardwired, dedicated state machine; or a combination of these. In one embodiment, controller 810 is of a programmable microcontroller solid-state integrated circuit type that includes a memory and one or more central processing units. Memory associated with controller 810 (if present) may be comprised of one or more components and may be of any volatile or nonvolatile type, including the solid-state variety, the optical media variety, the magnetic variety, a combination of these, or such different arrangement as would occur to those skilled in the art. Controller 810 further includes operating logic in the form of software instructions, hardware instructions, dedicated hardware, or the like that defines one or more control processes or the like.

In view of the foregoing, it will be appreciated that the embodiments exemplarily described above with respect to FIGS. 1 to 8 can be implemented for use in many different applications. For example, the embodiments described above can be implemented to machine a workpiece that is at least partially transparent or translucent when viewed in ambient or other incident light. Such a workpiece may include a transparent or translucent substrate 104 (e.g., a sheet of soda-lime glass) supporting a structure 102 such as a single layer (e.g., having a thickness, t1, of about 300 nm) of a material such as fluorine doped tin oxide. It will be appreciated that one or more other layers of material (e.g., tin oxide, silicon oxide, or the like or a combination thereof) may be interposed between the structure 102 and the substrate 104. The workpiece may be machined according to the process exemplarily described above to form recess 400 extending partially through the single layer of material. The recess 400 may extend to a depth, d, to produce an interference filter within the portion of the structure 102 corresponding to the thinned region 406. The depth, d, of the recess 400 (i.e., the thickness, t2, of the thinned region 406) can be controlled as exemplarily described above such that the apparent color of the workpiece at the location corresponding to the interference filter is perceptibly different (e.g., by the human eye, either aided or unaided) from the apparent color of another portion of the workpiece (e.g., at the location corresponding to the region 408). Such interference filters are known in the art, as evidenced by U.S. Pat. No. 6,666,983, which is incorporated herein by reference in its entirety. In one example, the workpiece may be machined (e.g., as exemplarily described above with respect to FIGS. 6 and 7) to produce a pattern of interference filters. Further, the apparent color (e.g., red, orange, yellow, green, blue, violet, etc.), size, shape, and location of each of the interference filters within the workpiece may be selected as desired such that a mark (e.g., a line, a logo, a graphic image, an alphanumeric character, or the like or a combination thereof) may be observed upon viewing the workpiece. It will be appreciated that such a workpiece may be incorporated within an electronic device (e.g., mobile phone, portable media player, personal digital assistant, computer, monitor, etc.) or may be provided as an article of architectural glass article, a novelty sign, or the like. It will further be appreciated that the embodiments exemplarily described above with respect to FIGS. 1 to 8 can be implemented in the production of articles such as diffractive optical elements, optical storage devices, transparent electronics, electrodes (e.g., fuel cell electrodes for light-assisted energy production devices, etc.), micro- or nano-fluidic devices (e.g., for use in chromatography, DNA sequencing, trace element/compound detection, etc.), or the like or a combination thereof.

In view of the foregoing, it is to be understood that the foregoing is illustrative of the invention and is not to be construed as limited to the specific example embodiments of the invention disclosed, and that modifications to the disclosed example embodiments, as well as other embodiments, are intended to be included within the scope of the appended claims. The invention is defined by the following claims, with equivalents of the claims to be included therein.

What is claimed is:

1. A method of machining a workpiece, the method comprising:
providing a workpiece including a structure having a first surface and a second surface opposite the first surface, wherein the first and second surfaces are defined by the same material; and
forming a recess within the structure, wherein the recess extends into the structure from the first surface and terminates at a recessed surface spaced apart from the second surface, wherein forming the recess includes:
directing a first optical pulse to impinge upon a first region of the first surface of the structure, wherein the first optical pulse is configured to initiate a vaporization process within a first period of time after impinging upon the first region;
after the first period of time, changing a characteristic of the first optical pulse while maintaining the initiated vaporization process; and
after a second period of time, terminating the first optical puke to terminate the maintained vaporization process.

2. The method of claim 1, wherein the workpiece comprises a substrate and the structure is provided as a single layer of the material on the substrate.

3. The method of claim 1, wherein the material includes a transparent conductive oxide.

4. The method of claim 3, wherein the transparent conductive oxide includes tin.

5. The method of claim 1, wherein the vaporization process includes a chemical reaction within he material.

6. The method of claim 5, wherein the chemical reaction includes a chemical dissociation of the material.

7. The method of claim 1, wherein the vaporization process includes a phase transition within the material.

8. The method of claim 7, wherein the phase transition includes sublimation of the material.

9. The method of claim 1, wherein the first optical pulse is a laser pulse.

10. The method of claim 9, wherein the laser pulse includes light having a wavelength and wherein the structure has a light transmittance of at least 90% with respect to the wavelength.

11. The method of claim 1, wherein the light is infrared light.

12. The method of claim 1, wherein the first optical pulse is configured such that, during the first period of time, the material is heated to a temperature greater than 1,200° C.

13. The method of claim 11, wherein the first optical pulse is configured such that, during the first period of time, the material is heated to a temperature less than 2,800° C.

14. The method of claim 1, wherein the first period of time is in a range from 0.1 ns to 5 ns.

15. The method of claim 1, wherein the second period of time is in a range from 1 ns to 600 ns.

16. The method of claim 1, wherein changing the characteristic of the first optical pulse to maintain the initiated vaporization process includes reducing a peak power of the first optical pulse generated during the first period of time by about 95%.

17. The method of claim 1, wherein forming the recess further comprises directing a second optical pulse to impinge upon a second region of the first surface of the structure after directing the first optical pulse to impinge upon the first region of the first surface of the structure.

18. The method of claim 1, wherein the recessed surface is spaced apart from the first surface by a distance such that a depth of the recess within the structure is in a range from 10 nm to less than 1 mm.

19. The method of claim 1, wherein a width of the recess at the first surface is in a range from 10 μm to 500 μm.

20. A method of machining a workpiece, the method comprising:
providing a workpiece including a structure having a measurable thickness between a first surface and a second surface opposite the first surface, wherein the first and second surfaces are defined by the same material; and
reducing the thickness of at least a portion of the structure to form a thinned region within the structure, wherein reducing the thickness includes:
directing an optical pulse to impinge upon the first surface of the structure, wherein the optical pulse is configured to generate a vaporization front at the first surface within a first period of time after impinging upon the first surface;
after the first period of time, changing a characteristic of the optical pulse while advancing the vaporization front into the structure and toward the second surface; and
after a second period of time, extinguishing the vaporization front.

21. The method of claim 20, wherein an optical property of the structure at the thinned region within the structure is different from a corresponding optical property at another region within the structure outside the thinned region.

22. The method of claim 20, wherein an electrical property of the structure at the thinned region within the structure is different from a corresponding electrical property at another region within the structure outside the thinned region.

23. An apparatus for machining a workpiece, the apparatus comprising:
a workpiece handling system configured to support a workpiece that includes a structure having a first surface and a second surface opposite the first surface, wherein the first and second surfaces are defined by the same material;
an optical source operative to generate an optical pulse that is directable onto the first surface of the structure; and
a controller coupled to the optical source, wherein the controller includes:
a memory; and
a processor configured to execute instructions stored in the memory to control the optical source to:
direct an optical pulse to impinge upon the first surface of the structure, wherein the optical pulse is configured to initiate a vaporization process within a first period of time after impinging upon the first surface;
after the first period of time, change a characteristic of the optical pulse to maintain the initiated vaporization process; and
after a second period of time, terminate the optical pulse to terminate the maintained vaporization process.
